(19) United States
(12) Patent Application Publication
(10) Pub. No.: US 2011/0056989 A1
(43) Pub. Date: Mar. 10, 2011

(54) Self defense apparatus

(76) Inventor: Louis Ceja, Midlothian, IL (US)

(21) Appl. No.: 12/807,207

(22) Filed: Aug. 30, 2010

Related U.S. Application Data
(60) Provisional application No. 61/238,781, filed on Sep. 1, 2009.

(51) Int. Cl. B67D 7/84

(52) U.S. Cl. 222/175; 222/478

(57) ABSTRACT

The present invention relates to a wearable self defense apparatus for emitting a spray, stream, cloud, mist or vapor of a deterrent when activated. The self defense apparatus is adapted to be worn on a person's lower arm or wrist and is activated when the wearer's writs breaks the plane of a critical angle thereby applying an appropriate force to activation tethers. The self defense apparatus may be adapted to be multistage such that prior to emission of deterrent, upon extension of one or more tethered digits, a warning alarm sounds, but no deterrent is emitted. Thereafter, upon flexing of the wearer's wrist past a critical angle, deterrent is emitted.

### CROSS-REFERENCE TO RELATED APPLICATIONS

This application claims priority to U.S. Provisional Patent Application Ser. No. 61/238,781 filed Sep. 1, 2009, the entire disclosure of which is incorporated herein by reference. Priority to this application is claimed under 35 U.S.C. §§119 and/or 120.

The present invention relates to a personal self defense apparatus. The apparatus is designed to be worn by a person on the wrist or lower arm such that it is relatively concealed from view while allowing the person's hands to remain free. Upon activation, the self defense apparatus embodied by the present invention is adapted to emit a substance designed to deter a potential assailant from assaulting the wearer.

### BACKGROUND OF THE INVENTION

Self defense devices have become a popular accessory for individuals. In the past, such devices were formed of a pressurized canister usually containing pepper spray or Mace®. The canisters were equipped with an activation mechanism that a person would activate using either a finger or thumb. Upon activation, the pressurized canister would emit a stream or spray of the deterrent such as pepper spray or Mace®.

Unfortunately, those canister devices suffer from numerous drawbacks. For instance, the canisters tended to be large and bulky with even the smallest versions being several inches long and roughly an inch in diameter. Their design required that they be grasped in the hand of the person desiring protection. Their bulk made them awkward and uncomfortable to carry and clearly restricted the use of that carrying hand. Consequently, the canisters were often carried in a person's pocket, purse or other bag which required the person to locate and extract the canister from the carrying locale when threatened.

Locating and extracting is time consuming and difficult especially when one is in a tense situation brought on by a would-be assailant. Moreover, once extracted, the person carrying the canister is further required to orient the canister such that any substance emitted is directed toward the assailant. That action, too, is time consuming and difficult when one has only moments to react.

It is therefore an object of the present invention to avoid the foregoing problems associated with prior devices by allowing a person to carry a self defense apparatus that keeps his or her hands free. Additionally, because the emitting sites of the self defense apparatus, which may be, for example, nozzles or even simple holes, maintain generally fixed relationships with the wearer's hand, there is no need to orient the self defense apparatus of the present invention prior to activation beyond simply aiming one's hand in the direction of the assailant.

### SUMMARY OF THE INVENTION

The personal self defense apparatus embodying the present invention comprises a casing having a cavity therein for holding a reservoir filled with a deterrent, the casing having two or more emitting sites in communication with the reservoir by at least one passage to allow for the emission of deterrent from the reservoir into the atmosphere. A carriage or at least one actuator is operatively connected to said casing and at least one tether is connected to the carriage or at least one actuator such that applying an appropriate force to said tether causes the carriage to move in an activation direction or causes at least one actuator to actuate thereby causing the emission of deterrent into the atmosphere. The tether or tethers connect to the carriage or at least one actuator as well as to at least one of a wearer's digits. The tethers are made of a flexible, preferably elastic, material. Flexing of the wearer's digits, wrist or both, past a critical angle applies an appropriate force to the tethers which then transmit the force to the carriage or at least one actuator which in turn causes the emission of deterrent into the atmosphere.

The self defense apparatus may be activated in a single stage or in multiple stages. For single stage activation, a wearer flexes the wrist and or at least one digit on the arm equipped with the self defense apparatus past a critical angle which causes a carriage or actuator to activate, resulting in the emission of deterrent into the atmosphere. For multistage activation, the wearer flexes either the wrist or at least one digit of the arm equipped with the self defense apparatus thereby causing an alarm to activate. Thereafter, the digit and/or wrist is flexed past the critical angle causing the emission of deterrent into the atmosphere.

### BRIEF DESCRIPTION OF THE DRAWINGS

FIG. 1 is a side view of a wearer's arm equipped with the self defense apparatus.

FIG. 2a is a plan view of a wearer's arm equipped with the self defense apparatus with the palm facing up.

FIG. 2b is a plan view of a wearer's arm equipped with the self defense apparatus with the palm facing down.

FIG. 3 is a close up view of one embodiment of the self defense apparatus.

FIG. 4 is a close up view of an alternate embodiment of the self defense apparatus.

FIG. 5 is a side view of a wearer's arm equipped with an alternate embodiment of the self defense apparatus.

FIG. 6 is a close up cutaway view of an alternate embodiment of the self defense apparatus.

FIGS. 7a, 7b, 8a and 8b are side views illustrating activation of the self defense apparatus by flexing the wearer's wrist and digits past a critical angle.

FIG. 9 is a close up cutaway view of an alternate embodiment of the self defense apparatus illustrating multiple reservoirs inside a casing.

FIGS. 9a, 9b and 9c are close up views of alternate embodiments of the self defense apparatus having biasing elements that bias a carriage against an activation direction.

FIG. 10 is an alternate embodiment of the self defense apparatus.

### DETAILED DESCRIPTION OF THE PREFERRED EMBODIMENT

For the purpose of further understanding the principles of the present invention, the preferred embodiments of the invention will be described in detail below. All of the embodiments of the present invention comprise many of the same elements; therefore the same numerals will be used from figure to figure to identify like elements.

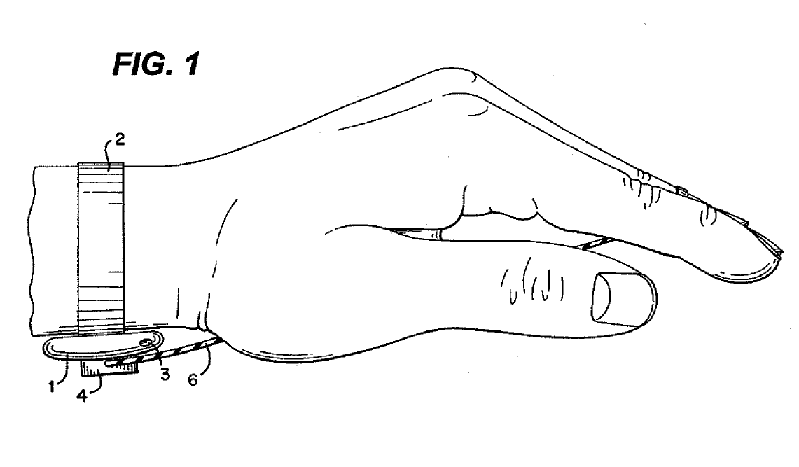

FIG. 1 is a general depiction of the present invention which is constructed of a casing 1 that is affixed to a band 2. Generally, the casing is of a round or oval shape, though other shapes, such as heart, diamond or other polygon shapes, could be used. As the present invention is designed to be worn on a person's lower arm, and preferably on one's wrist, the band 2 may exhibit a construction similar to that of a wristwatch or be constructed of a single piece of elastic material to encircle the wearer's arm and thereby secure the casing 1 to the wearer's arm.

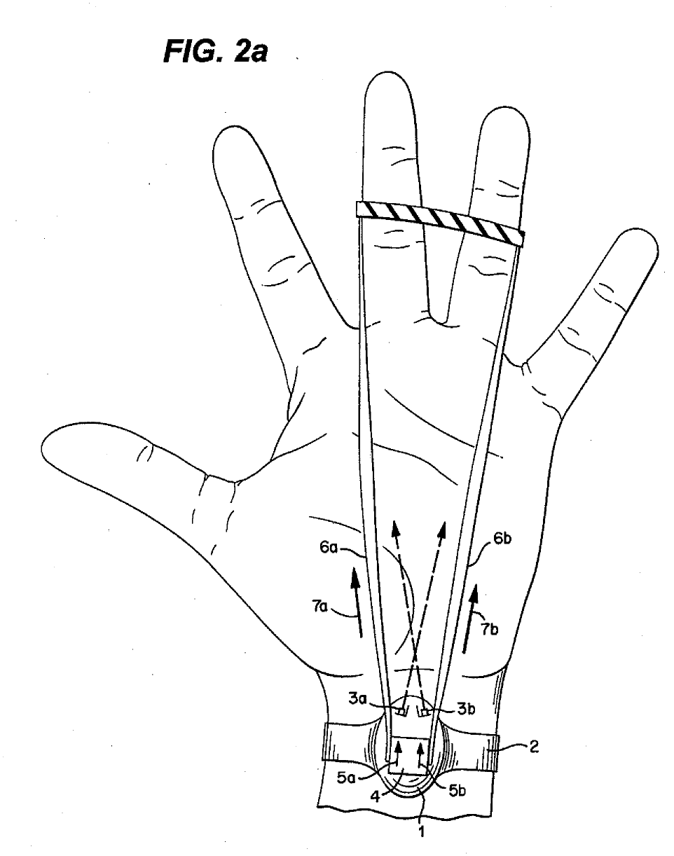

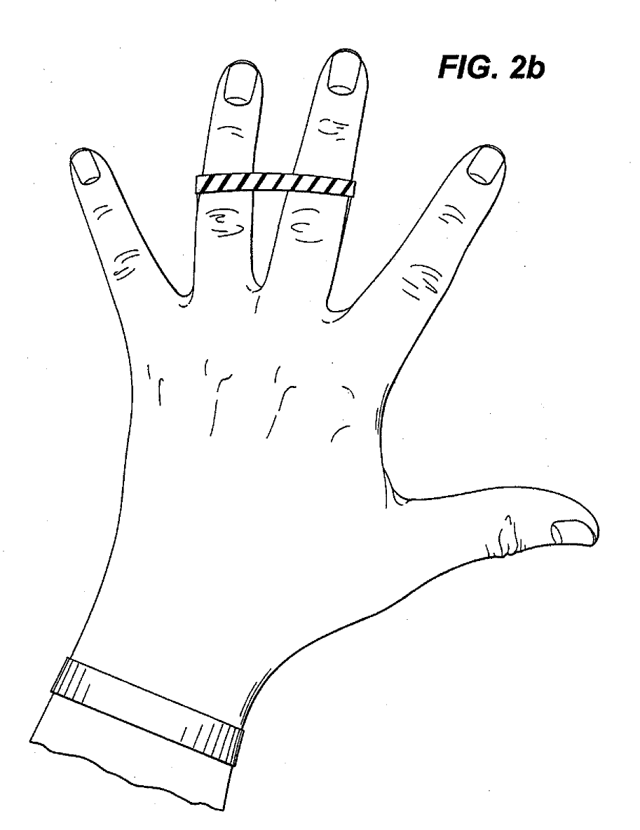

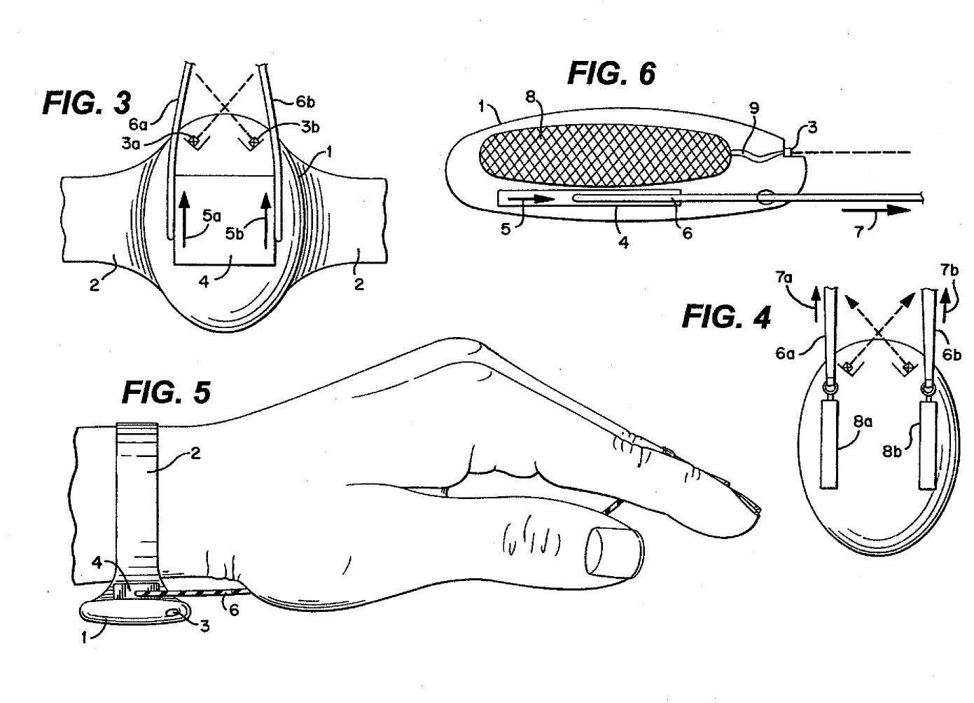

FIG. 2a depicts an embodiment of the invention worn on the underside of a person's lower arm or wrist, shown with the palm facing up. FIG. 2b depicts an embodiment of the invention worn on the underside of a person's lower arm or wrist, shown with the palm facing down. Referring. to FIG. 3, casing 1 is provided with two emitting sites 3a and 3b. It is preferred that the invention be provided with at least two emitting sites though additional emitting sites (i.e., more than two) may be provided. The emitting sites may be of the same general construction or of differing constructions so that each may be adapted to optimally emit one or more particular deterrents.

The casing 1 includes a reservoir (not shown) that contains one or more deterrents. Emitting sites 3a and 3b are connected to the reservoir by at least one passageway (not shown). The passageway allows for the transmission of deterrent from the reservoir to emitting sites 3a and 3b upon activation of the self defense apparatus. Though a single passageway could be used to connect the emitting sites to the reservoir, it is preferred that each emitting site is connected to the reservoir by its own dedicated passageway. In an embodiment utilizing multiple passageways, if one passageway to one emitting site clogs, there remains at least a second passageway connected to a second emitting site that may still function to emit deterrent. Furthermore, the emitting sites may also be mounted flush to the reservoir; in such cases, the passageways and the emitting sites are one in the same.

As shown in FIGS. 2a and 3, carriage 4 is operatively connected to casing 1 such that the carriage moves with respect to casing 1 as indicated by directional arrows 5a and 5b. At least one tether is connected to the carriage. The embodiment depicted in FIGS. 2a and 3 utilizes two tethers 6a and 6b, although any number of tethers (i.e., one or more) could be used. Regardless of the number of tethers utilized, one end of each tether is designed to be worn on at least one of the wearer's digits. In the embodiment depicted in FIG. 2a, tether 6a and tether 6b are adapted to be worn around the ring finger and the middle finger.

Though the tethers may terminate in simple loops (not shown) designed to slip over the wearer's fingers, the tethers may also be connected to a ring fitting, such as a piece of rope, elastic, plastic or metal, that fits around one or more of the wearer's digits. Furthermore, while the ring fitting may be of unitary construction, it may also be divided such that each digit maintains independent mobility. And, in embodiments where the self defense apparatus is equipped with multiple tethers, each tether may be attached to its own ring fitting or all tethers may be connected to one or more ring fittings.

Though the tethers could be worn in any position along the length of any of the wearer's digits, it is preferred that the tethers are worn around at least one of the wearer's fingers and further preferred that the tethers are worn around the wearer's middle finger (in the case of one tether) or the middle finger and ring finger as shown in FIG. 2a (in the case of two tethers). Also as shown in FIG. 2a, it is further preferred that the tethers are worn between the wearer's top and middle knuckles around the middle phalanges of the wearer's digits. That positioning allows the wearer to maintain a wide range of motion with his or her hand, wrist and digits without activating the self defense apparatus while reducing the risk that the tethers might slip off of the wearer's digits as could happen if the tethers were worn around the top phalanges of the wearer's digits.

The origin end (opposite the end connected to the wearer's digit) of each tether is connected to the carriage 4 such that when force is applied to the tethers in the direction of arrows 7a and 7b, as shown in FIG. 2a, the tethers cause the carriage to move in the direction indicated by arrows 5a and 5b. It should be apparent that the origin end of the tethers need not be directly connected to the carriage, but may also be connected through intermediary pieces that transmit forces experienced by the tethers to act on the carriage. Additionally, it should be apparent that the self defense apparatus could be adapted such that an appropriate force applied in the direction of arrows 7a and 7b could cause the carriage 4 to move in a direction other than the direction indicated by arrows 5a and 5b, such as backward, upward or downward, thereby causing the release of deterrent.

The tethers are constructed of a flexible material which allows the wearer of the self defense apparatus to maintain a significant range of motion of his or her wrist, hand and digits without activating the self defense apparatus. Preferably, the tethers are constructed of a flexible and elastic material such as rubber or stretchable nylon, as an elastic material allows the wearer to maintain the greatest range of motion. However, other materials, such as a flexible but static material such as string, cording, wire or flexible plastic could also be used to construct the tethers as these materials also allow the wearer to maintain much of their normal range of motion.

In an alternate embodiment, one or more actuators 8a and 8b such as pistons, switches or other actuators are attached to the casing, as shown in FIG. 4, such that activation of the one or more actuators causes the self defense apparatus to emit deterrent into the atmosphere. In that embodiment, the origin ends of the tethers are attached to the one or more actuators and a carriage is unnecessary. Thus, applying an appropriate force to the tethers in the direction of arrows 7a and 7b in FIG. 4, causes the tethers to actuate the one or more actuators thereby releasing deterrent into the atmosphere.

In the embodiment depicted in FIGS. 2a and 3, the carriage 4 is operatively connected to the outside of casing 1 on the lower side of the casing (i.e., the side facing away from the wearer's arm). Because, in the FIG. 3 embodiment, the carriage is exposed on the outside of casing, it is possible that an external force (i.e., a force other than one supplied by the wearer supplying a force to the tethers) could act on the carriage, causing it to unintentionally move with respect to the casing and emit deterrent. To avoid such unintentional activation, the embodiment shown in FIG. 2a could be altered such that the carriage could be mounted on the inner side of the casing (i.e., the side closest to the wearer's arm), as shown in FIG. 5. Thus, the carriage would be mounted between the wearer's arm and the casing. Similarly, the embodiment shown in FIG. 5 could be altered such that the one or more actuators are located on the inner side of the casing between the casing and the wearer's arm.

A further alternate embodiment of the invention could protect the carriage from external forces by being supplied to an interior cavity of the casing 1. In the FIG. 6 embodiment, casing 1 is supplied with a cavity adapted to hold the carriage 4. The casing also contains at least one reservoir 8 for holding deterrent and passageway 9 in communication with emitting sites 3. The carriage is operatively connected to the casing within the cavity. Furthermore, the origin ends of the tethers are connected to carriage 4 (as described with respect to the FIG. 2a embodiment). However, in the FIG. 6 embodiment, the connections are made on the inside of casing 1 instead of on the outside.

As with the other embodiments, when an appropriate force is applied to the tethers (again, one or more tethers may be used) in the direction indicated by arrow 7, the carriage moves in the direction indicated by arrow 5 and causes deterrent to be emitted from the emitting sites into the atmosphere.

Additionally, the embodiment shown in FIG. 4, which utilizes one or more actuators 8a and 8b located outside of the casing, could be adapted such that the one or more actuators are supplied within a cavity located inside of the casing 1. In such an embodiment, the origin ends of tethers 6a and 6b are connected to the one or more actuators just as described with respect to the FIG. 4 embodiment. However, instead of making the connections on the outside of casing 1, the connections are made on the inside of casing 1. As with the other embodiments, when an appropriate force is applied to the tethers (again, one or more tethers may be used), the one or more actuators are activated causing deterrent to be emitted from the emitting sites into the atmosphere.

### Activation

In order to activate any of the aforementioned embodiments, a wearer must supply an appropriate force to the one or more tethers to either move the carriage with respect to the casing or to activate the one or more actuators. Referring to the preferred embodiments of present invention as illustrative, such appropriate force may be supplied in one of two ways depending on the orientation of the self defense apparatus on the wearer's arm.

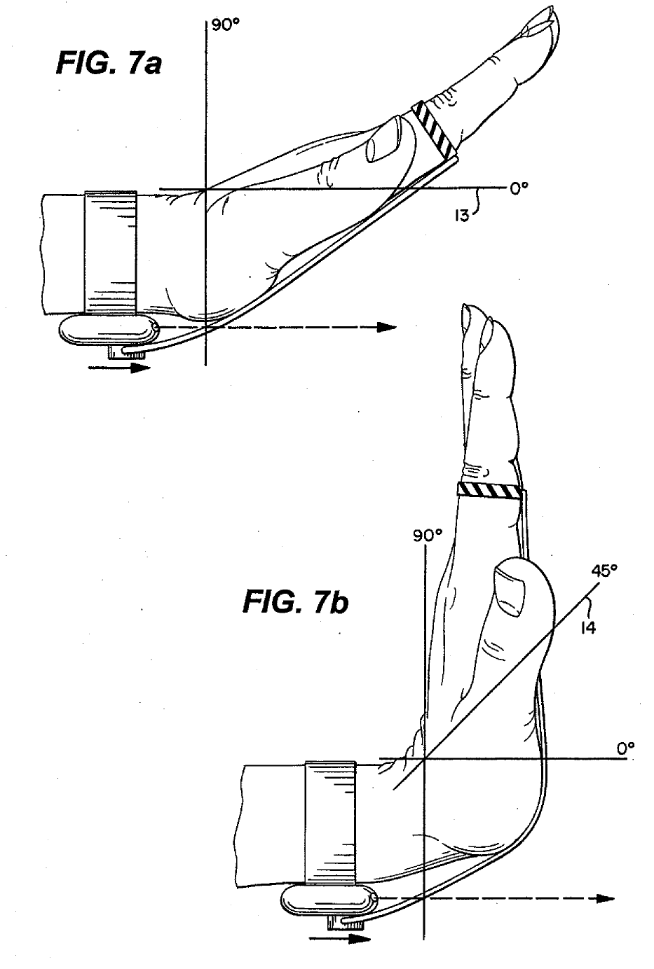

When worn in orientation A, shown in FIGS. 7a and 7b, the wrist of the wearer is flexed in the upward direction to activate the self defense apparatus. When the wearer's wrist breaks the zero degree plane 13 (thereby crossing the critical angle of zero degrees), a force is supplied to the tethers. That force is further transmitted to the carriage causing the carriage 4 to move forward and emit deterrent (or causing actuators to actuate and emit deterrent). It is preferred that the wearer maintain as much range of motion in the wearers digits and wrist as possible; thus it is preferred that the wearer's wrist flex through the forty-five degree) (+45° plane 14 (thereby crossing the critical angle of forty-five degrees) before the carriage is moved forward and emits deterrent or before the actuators are caused to actuate and emit deterrent.

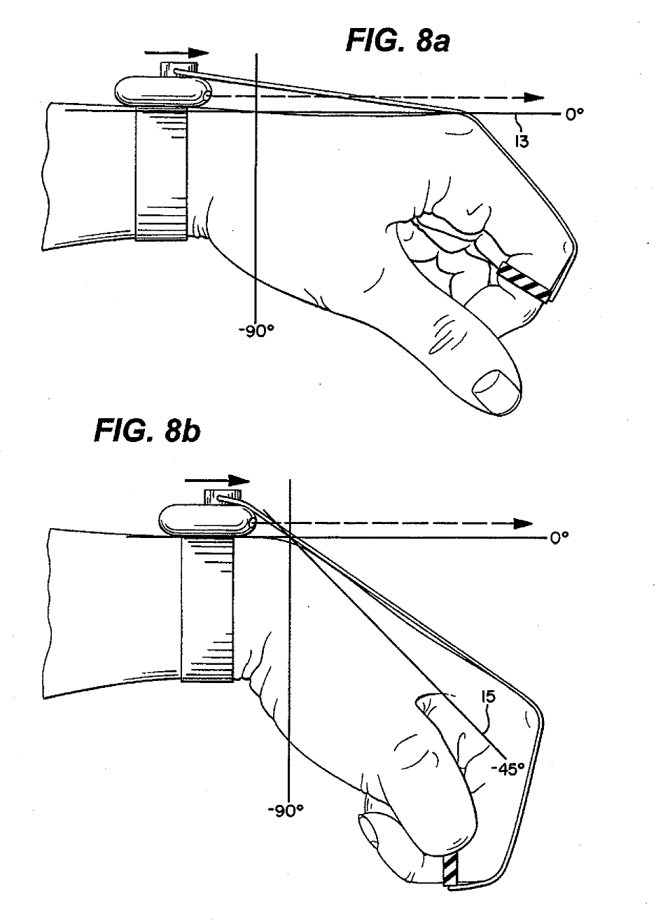

When worn in orientation B, shown in FIGS. 8a and 8b, the wrist of the wearer is flexed in the downward direction to activate the self defense apparatus. When the wearer's wrist breaks the zero degree plane 13 (thereby crossing the critical angle of zero degrees), a force is supplied to the tethers. That force is further transmitted to the carriage causing the carriage to move forward and emit deterrent or causing the actuators to actuate and emit deterrent. It is preferred that the wearer maintain as much range of motion in the wearers digits and wrist as possible; thus it is preferred that the wearer's wrist flex through the negative forty-five degree (−45°) plane 15 (thereby crossing the critical angle of negative forty-five degrees) before the carriage is moved forward and emits deterrent or before the actuators actuate and emit deterrent.

It should be apparent that the preferred critical angle (i.e., the angle that, when surpassed, causes activation of the self defense apparatus) could be anywhere between zero and ninety degrees when the self defense apparatus is worn in orientation A and anywhere between zero and negative ninety degrees when the self defense apparatus is worn in orientation B.

Alternately, activation may be achieved through a two stage operation. In a two stage operation, for example, the wearer extends the fingers having the tethers attached to them and bends the wrist of the arm wearing the self defense apparatus past the critical angle before the self defense apparatus is activated to emit deterrent into the atmosphere. The order in which the actions of extending the fingers and bending the wrist occur is inconsequential; either may be done before or after the other, or even simultaneously.

In an embodiment of the invention utilizing the two stage activation, it is preferred that the self defense apparatus is equipped with an alarm signifying that the first stage has been achieved. For example, the wearer may first extend the fingers having the tethers attached and, upon extension, the alarm would activate signifying that the first stage was accomplished. Thereafter the wearer would flex the wrist of the arm wearing the self defense apparatus causing the self defense apparatus to emit deterrent into the atmosphere.

Alternately, the wearer could first flex the wrist of the arm wearing the self defense apparatus past the critical angle so that, upon passing the critical angle, the alarm would activate. Thereafter the wearer would extend the fingers having the tethers attached causing the self defense apparatus to emit deterrent into the atmosphere.

### Orientation of Emitting Sites

As discussed above, in the preferred embodiments of the present invention, the self defense apparatus may be equipped with at least one but preferably two or more emitting sites. As illustrated, the emitting sites are oriented so as to face forward such that each emitting site emits a spray, stream, cloud, mist or vapor along parallel axes. However, as further depicted in the embodiments disclosed herein, at least two of the emitting sites are oriented at angles to one another such that the axes of emission of those angled emitting sites cross one another. Angling the emitting sites toward one another, helps the sprays, streams, clouds, mists or vapors to be emitted from the emitting sites to intersect. The intersection of the sprays, streams, clouds, mists or vapors aids in the dispersion of deterrent.

### The Deterrent

The present invention utilizes a deterrent that is emitted from the self defense apparatus to deter a would-be assailant from engaging in or continuing an attack on the wearer of the invention. The deterrent can be one or more of any number of deterrents such as pepper spray, Mace® or tear gas or even a coloring agent such as dye or paint or any similar deterrent that may be emitted as, for example, a spray, mist, cloud, vapor, stream or the like. Indeed, it is possible that the deterrent could be a concentrated solution of salt water which, when emitted in the direction of an assailant's face, could temporarily disable the assailant.

In addition, one or more deterrents may be emitted from the invention simultaneously. Therefore, in the embodiments described above, the casing reservoir may be filled with any combination of the aforementioned deterrents. For example, if the casing 1 were filled with only with a first deterrent, such as pepper spray, upon activation, the invention would emit pepper spray from each of the emitting sites. But, if the casing were filled with a first deterrent, such as pepper spray and a second deterrent, such as dye, upon activation, the invention would emit pepper spray from at least one emitting site and the invention would simultaneously emit dye from at least one emitting site such that deterrent is emitted from at least two emitting sites.

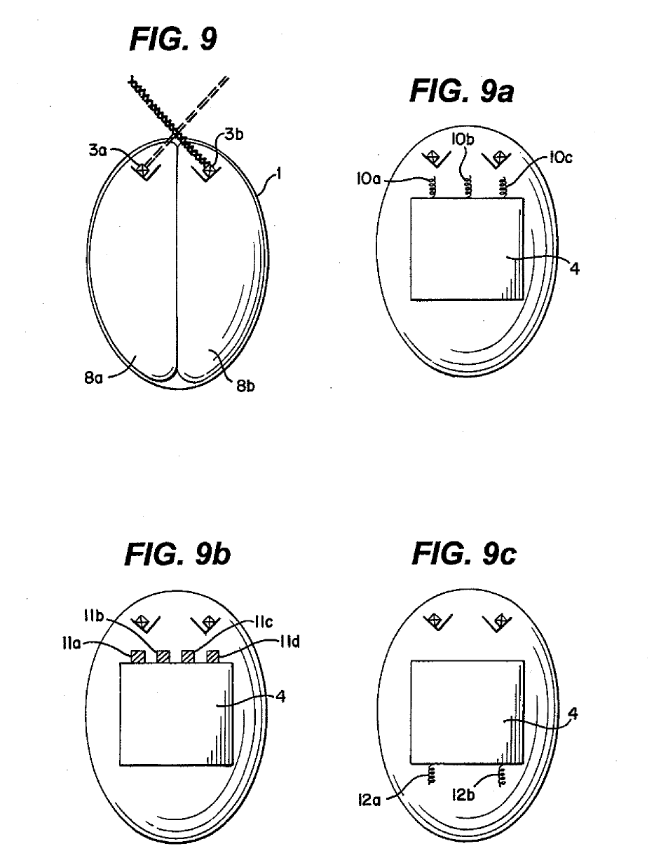

As mentioned above, the casing reservoir may contain one or more deterrents. Thus, the casing reservoir may be of unitary construction or may be of multiple separate chambers such that each chamber houses a reservoir that contains a separate deterrent. Upon activation, the deterrents from the separate reservoirs are emitted from the emitting sites of the self defense apparatus. Thus, multiple separate reservoirs could be supplied within the casing. Upon activation, the deterrents in the separate reservoirs would be emitted from the emitting sites of the self defense apparatus. For embodiments utilizing multiple deterrents, it is preferred that each deterrent emitting site is allocated exclusively to emit a single deterrent at a time. Thus, as shown in FIG. 9 (a simplified view), a first deterrent from reservoir 8a is emitted from emitting site 3a and a second deterrent from reservoir 8b is emitted from emitting site 3b.

### Biasing

In the embodiments of FIGS. 9a, 9b and 9c, it further shown that the carriage 4 may be biased toward the back of the self defense apparatus (i.e., toward the wearer's elbow, opposite of the activation direction) by way of one or more springs or a resilient substance, for example, rubber or foam. In FIG. 9a, the carriage 4 is biased using compression springs 10a, 10b and 10c. In FIG. 9b, the carriage 4 is biased using a resilient compression material 11a, 11b, 11c and 11d. In FIG. 9c, the carriage 4 is biased using tension springs 12a and 12b. Biasing the carriage prevents the carriage from unintentionally moving in the activation direction and activating the self defense apparatus while allowing a wearer to apply an appropriate force to the tethers in order to move the carriage and cause the self defense apparatus to emit deterrent. It should be apparent that the springs or resilient material need not be provided in the particular numbers depicted but need only be provided in a sufficient manner to bias the carriage 4.

Finally, it should be appreciated that any of the embodiments of FIGS. 9a, 9b and 9c could be adapted such that providing an appropriate force on the tethers causes the carriage to move in a direction other than forward (i.e., backwards, sideways, up, or down) relative to the casing and thereby activate the self defense apparatus causing it to emit deterrent into the atmosphere. If the self defense apparatus is altered as described, thereby changing the activation direction from forward to another direction, the self defense apparatus could further be adapted to be biased in the direction opposite that of the activation direction.

### FURTHER EMBODIMENTS OF THE INVENTION

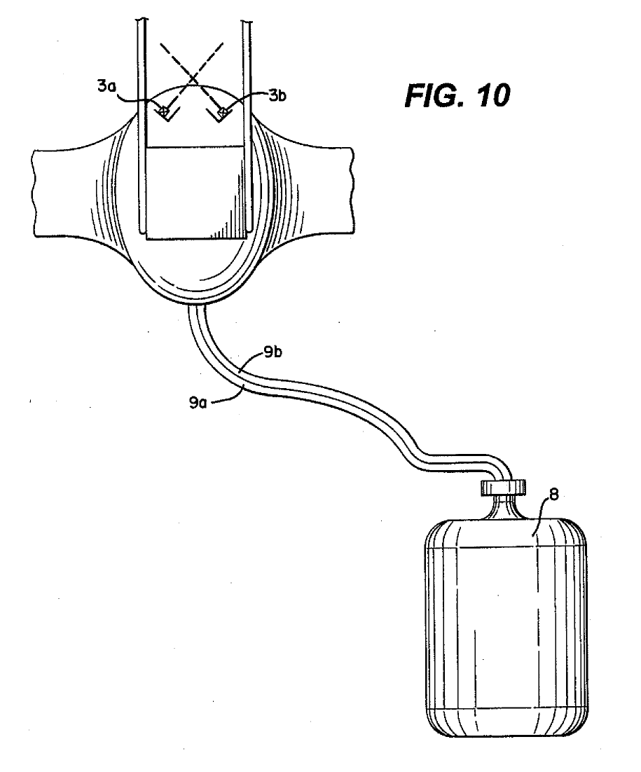

A further embodiment of the invention is depicted in FIG. 10. According to that embodiment, the deterrent reservoir is located remotely from the casing. As with previous embodiments of the invention, the casing is provided with one or more (preferably two) emitting sites, and one or more passageways connecting the reservoir to the emitting sites. In the embodiment of FIG. 10 two passageways 9a and 9b are connected to emitting sites 3a and 3b and to the reservoir 8. Each passageway may be connected to the same reservoir, or each passageway may be connected to a different reservoir (not shown). The self defense apparatus according to this further embodiment is activated through single or multistage activation all as described above.

Further embodiments of the invention may include a recording device, a light source or both. Accordingly, at least one light source, such as an LED, is attached to the self defense apparatus. The light source may be activated by either a switch or simply by actuating the self defense apparatus (in either one stage or multistage actuation as described above) or both. A further alternate embodiment includes one or more recording devices. Accordingly, the recoding device may be, for example, an audio recorder, video recorder, still frame camera, or some combination of recording devices. The recoding device may be activated by way of a switch or simply by activating the self defense apparatus (in either one stage or multistage actuation as described above). Also, the self defense apparatus could be equipped with both a light source and a recording device as well as other features described herein.

As discussed above, the light source and recording device may be activated by actuating the self defense apparatus by way of multistage activation. Utilizing multistage actuation the self defense apparatus may be configured to activate different elements at different critical angles. That is, in a particular embodiment, the wearer could activate the alarm and LED at a first critical angle, activate the recording device at a second, further critical angle and finally activate the carriage or actuators at a third, further critical angle thereby causing deterrent to be emitted into the atmosphere.

It should be apparent that the above description of the present invention is susceptible to various modifications, changes and adaptations, and the same are intended to be equivalents and to be within the meaning and scope of the appended claims.

What is claimed is:

1. A self defense apparatus to be worn on a person's lower arm comprising:
a band and a casing, said casing containing having at least one interior cavity for holding at least one deterrent;
one or more emitting sites connected to said casing;
a carriage operatively connected to said casing; and
at least one tether operatively connected to said carriage wherein at least one said tether made of a flexible material.

2. A self defense apparatus to be worn on a person's lower arm as in claim 1 further comprising a resilient material for biasing said carriage in a direction opposite an activation direction wherein the activation direction is the direction in which the tethers force the carriage to move in order to activate the self defense apparatus to emit deterrent into the atmosphere.

3. A self defense apparatus to be worn on a person's lower arm as in claim 1 including a light source.

4. A self defense apparatus to be worn on a person's lower arm as in claim 1 wherein at least two of said emitting sites are oriented such that they are angled toward each other such that deterrent emitted from at least one emitting site is emitted along an axis that intersects the axis of at least one other emitting site.

5. A self defense apparatus to be worn on a person's lower arm as in claim 1 wherein the distal end of at least one tether terminates in a loop or ring fitting to be worn around at least one of a person's digits.

6. A self defense apparatus to be worn on a person's lower arm as in claim 5 wherein the distal end of at least one tether terminates in a loop or ring fitting to be worn around the middle phalange of at least one of a person's fingers.

7. A self defense apparatus to be worn on a person's lower arm as in claim 1 wherein the tether is made of a flexible and elastic material.

8. A self defense apparatus to be worn on a person's lower arm as in claim 1 wherein said carriage is biased against an activation direction by one or more springs or one or more pieces of resilient material.

9. A self defense apparatus to be worn on a person's lower arm as in claim 1 wherein said casing contains more than one reservoir, at least one of said reservoirs containing a deterrent different than that of another one of said reservoirs.

10. A self defense apparatus to be worn on a person's lower arm as in claim 1 further including an alarm that activates prior to the emission of deterrent into the atmosphere.

11. A self defense apparatus comprising:
a band and a casing, said casing containing a deterrent;
one or more emitting sites connected to said casing;
one or more actuators operatively connected to said casing; and
at least one tether operatively connected to said one or more actuators.

12. A self defense apparatus to be worn on a person's lower arm as in claim 11 further comprising a resilient material for biasing said one or more actuators in a direction opposite an activation direction wherein the activation direction is the direction in which the tethers force the one or more actuators to move in order to activate the self defense apparatus to emit deterrent into the atmosphere.

13. A self defense apparatus to be worn on a person's lower arm as in claim 11 including a light source.

14. A self defense apparatus to be worn on a person's lower arm as in claim 11 wherein at least two of said emitting sites are oriented such that they are angled toward each other such that deterrent emitted from at least one emitting site is emitted along an axis that intersects the axis of at least one other emitting site.

15. A self defense apparatus to be worn on a person's lower arm as in claim 11 wherein the distal end of at least one tether terminates in a loop or ring fitting to be worn around at least one of a person's digits.

16. A self defense apparatus to be worn on a person's lower arm as in claim 15 wherein the distal end of at least one tether terminates in a loop or ring fitting to be worn around the middle phalange of at least one of a person's fingers.

17. A self defense apparatus to be worn on a person's lower arm as in claim 11 wherein the tether is made of a flexible and elastic material.

18. A self defense apparatus to be worn on a person's lower arm as in claim 11 wherein said one or more actuators is biased against an activation direction by one or more springs or one or more pieces of resilient material.

19. A self defense apparatus to be worn on a person's lower arm as in claim 11 wherein said casing contains more than one reservoir, at least one of said reservoirs containing a deterrent different than that of another one of said reservoirs.

20. A self defense apparatus to be worn on a person's lower arm as in claim 11 further including an alarm that activates prior to the emission of deterrent into the atmosphere.

21. A self defense apparatus to be worn on a person's lower arm as in claim 11 further including a recording device.

22. A self defense apparatus to be worn on a person's lower arm as in claim 1 further including a recording device.

23. A self defense apparatus to be worn on a person's lower arm comprising:
a band and a casing;
one or more emitting sites connected to said casing;
one or more passageways connecting said emitting sites to a reservoir, the reservoir being located remotely from said casing;
a carriage or at least one actuator operatively connected to said casing; and
at least one tether operatively connected to said carriage or at least one actuator wherein said at least one tether made of a flexible material.
